(19) United States
(12) Patent Application Publication
(10) Pub. No.: US 2025/0347245 A1
(43) Pub. Date: Nov. 13, 2025

(54) VARIABLE CAPACITY-TYPE SUPERCHARGER WITH NOZZLE ASSEMBLY ENGAGEMENT MECHANISM

(71) Applicant: IHI Corporation, Tokyo (JP)

(72) Inventor: Seiya NAKAZAWA, Tokyo (JP)

(21) Appl. No.: 19/278,791

(22) Filed: Jul. 24, 2025

Related U.S. Application Data
(63) Continuation of application No. PCT/JP2023/031032, filed on Aug. 28, 2023.

(30) Foreign Application Priority Data
Jan. 27, 2023 (JP) 2023-010926

(51) Int. Cl. F02B 37/24; F02C 6/12

(52) U.S. Cl. CPC F02B 37/24; F02C 6/12; F05D 2220/40; F05D 2240/128

(57) ABSTRACT

A variable capacity turbocharger includes: a turbine impeller; a turbine housing accommodating the turbine impeller; a nozzle flow passage located around the turbine impeller in the turbine housing; a variable nozzle assembly having a nozzle vane located in the nozzle flow passage, and a drive mechanism configured to drive the nozzle vane; and an engagement mechanism configured to restrict a rotational position of the variable nozzle assembly. The engagement mechanism is located in a region radially outside a movable range of the nozzle vane in a radial direction of rotation of the turbine impeller.

### CROSS-REFERENCE TO RELATED APPLICATIONS

This application is a continuation application of PCT Application No. PCT/JP2023/031032, filed on Aug. 28, 2023, which claims the benefit of priority from Japanese Patent Application No. 2023-010926, filed on Jan. 27, 2023. The entire contents of the above listed PCT and priority applications are incorporated herein by reference.

### BACKGROUND

### Field

The present disclosure relates to a variable capacity turbocharger.

### Description of the Related Art

Japanese Unexamined Patent Application Publication No. 2013-68153 discloses a variable capacity turbocharger. The turbocharger has a variable nozzle unit for adjusting aperture of a nozzle flow passage of a turbine. Between the variable nozzle unit and a bearing housing, there is provided a disc spring by which the variable nozzle unit is biased and pressed against a turbine housing, thereby being positioned in the axial direction.

### SUMMARY

For the turbocharger having the variable nozzle unit, in need of positioning the variable nozzle unit in a plane orthogonal to the axial direction, a possible structure may be such that a pin that extends in the axial direction is press-fitted to the bearing housing, and the pin is fitted to a pin hole formed in the variable nozzle unit, while leaving a clearance. The disc spring load will, however, decrease during operation of the turbocharger, as the disc spring deforms under heating or reduces the Young's modulus. This would reduce frictional force between the variable nozzle unit and the turbine housing, and would cause circumferential shift of the variable nozzle unit just as much as the clearance between the pin and the pin hole. The circumferential shift of the variable nozzle unit will result in change in the gas flow rate.

Disclosed herein is an example variable capacity turbocharger including: a turbine housing that accommodates a turbine impeller; a variable nozzle unit having a nozzle vane arranged in a nozzle flow passage provided around the turbine impeller in the turbine housing, and a drive mechanism structured to drive the nozzle vane; a biasing part structured to bias the variable nozzle unit in a direction of a rotation axis of the turbine impeller so as to be pressed against a part of the turbine housing; and an engagement structure structured so that a predetermined part thereof engages with the variable nozzle unit so as to restrict shifting of the variable nozzle unit in a circumferential direction of rotation of the turbine impeller. The engagement structure is located in a region radially outside, in a radial direction of rotation of the turbine impeller, of a movable range of the nozzle vane.

### BRIEF DESCRIPTION OF THE DRAWINGS

FIG. 1 is a cross-sectional view illustrating an example variable capacity turbocharger.

FIG. 2 is an exploded perspective view illustrating a variable nozzle unit and so forth.

FIG. 3 is a plan view illustrating the variable nozzle unit as viewed in the axial direction from a bearing housing side.

FIG. 4 is an enlarged cross-sectional view illustrating an area at and around the variable nozzle unit of the variable capacity turbocharger.

FIG. 5 is a drawing illustrating a nozzle ring and a nozzle vane viewed in an axial direction from a turbine side.

FIG. 6A is a perspective view illustrating the nozzle ring to which an example engagement structure is applied.

FIG. 6B is an enlarged cross-sectional view illustrating the engagement structure, which is illustrated in FIG. 6A.

FIG. 6C is a drawing illustrating the engagement structure viewed from a direction of arrow VIc.

FIG. 7A is a perspective view illustrating the nozzle ring to which an example engagement structure is applied.

FIG. 7B is an enlarged cross-sectional view illustrating an example engagement structure.

FIG. 7C is a drawing illustrating an example engagement structure viewed from a direction of arrow VIIc.

FIG. 8A is a perspective view illustrating the nozzle ring to which an example engagement structure is applied.

FIG. 8B is an enlarged cross-sectional view illustrating the engagement structure, which is illustrated FIG. 8A.

FIG. 8C is a drawing illustrating the engagement structure, which is illustrated in FIG. 8A, viewed from a direction of arrow VIIIc.

FIG. 9A is a perspective view illustrating the nozzle ring to which an example engagement structure is applied.

FIG. 9B is an enlarged cross-sectional view illustrating the engagement structure, which is illustrated in FIG. 9A.

FIG. 9C is a drawing illustrating the engagement structure, which is illustrated in FIG. 9A, viewed from a direction of arrow IXc.

FIG. 10A is a perspective view illustrating the nozzle ring to which an example engagement is applied.

FIG. 10B is an enlarged cross-sectional view illustrating the engagement structure, which is illustrated in FIG. 10A.

FIG. 10C is a drawing illustrating the engagement structure, which is illustrated in FIG. 10A, viewed from a direction of arrow Xc.

FIG. 11 is a cross-sectional view illustrating a structure for restricting shifting of the variable nozzle unit in a circumferential direction, in a prior turbocharger.

### DETAILED DESCRIPTION

Disclosed herein is an example variable capacity turbocharger including: a turbine housing that accommodates a turbine impeller; a variable nozzle unit having a nozzle vane arranged in a nozzle flow passage provided around the turbine impeller in the turbine housing, and a drive mechanism structured to drive the nozzle vane; a biasing part structured to bias the variable nozzle unit in a direction of a rotation axis of the turbine impeller so as to be pressed against a part of the turbine housing; and an engagement mechanism structured so that a predetermined part thereof engages with the variable nozzle unit so as to restrict shifting of the variable nozzle unit in a circumferential direction of rotation of the turbine impeller. The engagement mechanism being located in a region radially outside, in a radial direction of rotation of the turbine impeller, of a movable range of the nozzle vane.

In the variable capacity turbocharger, the variable nozzle unit may have a flange that is provided so as to protrude most outwardly in the radial direction when looked over the variable nozzle unit. The flange may be pressed under biasing force of the biasing part against a flange catcher of the turbine housing, in the direction of rotation axis. In the engagement mechanism, a part of the flange engages directly or indirectly with the predetermined part.

In the variable capacity turbocharger, the engagement mechanism may have a notch formed so as to be cut from an outermost end face of the flange towards the inner circumferential side; and a pin that extends from the turbine housing and is inserted into the notch.

In the variable capacity turbocharger, the engagement mechanism may have a pin that extends from either one of the flange or the turbine housing; and a pin hole provided to other one of the flange or the turbine housing, into which the pin is inserted.

In the variable capacity turbocharger, the engagement mechanism may have a protrusion provided to either one of the flange or the flange catcher; and a recess provided to other one of the flange or the flange catcher, into which the protrusion is fitted.

In the following description, with reference to the drawings, the same reference numbers are assigned to the same components or to similar components having the same function, and overlapping description is omitted.

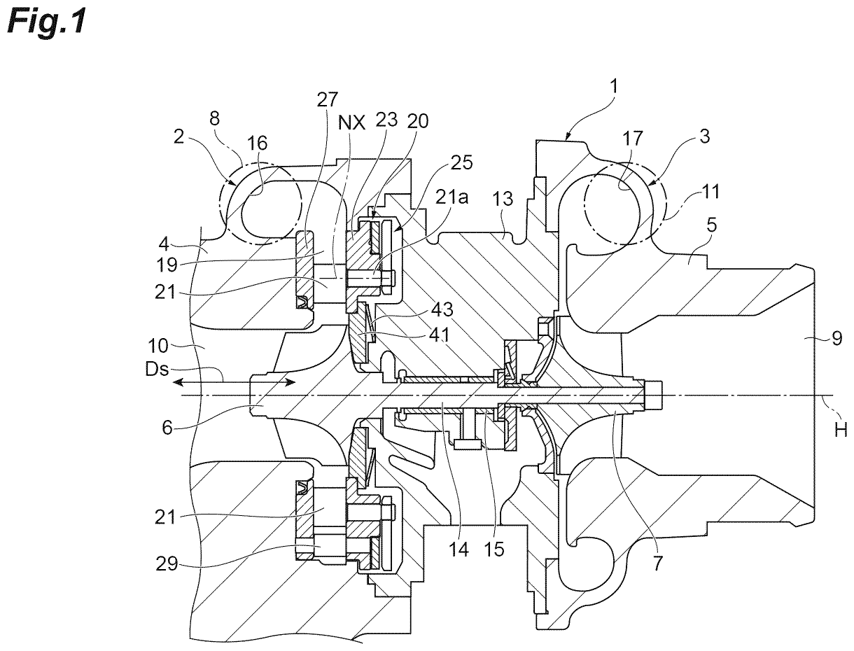

FIG. 1 is a cross-sectional view illustrating a cross section taken along a rotation axis H of the variable capacity turbocharger 1. The variable capacity turbocharger 1 is applicable to an internal combustion engine of ships or vehicles.

As illustrated in FIG. 1, the turbocharger 1 has a turbine 2 and a compressor 3. The turbine 2 has a turbine housing 4, and a turbine impeller 6 accommodated in the turbine housing 4. The turbine housing 4 has a scroll flow passage 16 that extends in the circumferential direction Dc around the turbine impeller 6. The compressor 3 has a compressor housing 5, and a compressor impeller 7 accommodated in the compressor housing 5. The compressor housing 5 has a scroll flow passage 17 that extends in the circumferential direction Dc around the compressor impeller 7.

The turbine impeller 6 is provided to one end of a rotating shaft 14, and the compressor impeller 7 is provided to the other end of the rotating shaft 14. Between the turbine housing 4 and the compressor housing 5, there is provided a bearing housing 13. The rotating shaft 14 is rotatably supported by the bearing housing 13, intermediated by a bearing 15, whereby the rotating shaft 14, the turbine impeller 6, and the compressor impeller 7 rotate, as an integrated rotating body, around the rotation axis H.

The turbine housing 4 is provided with an exhaust gas inlet 8 and an exhaust gas outlet 10. Exhaust gas discharged from an internal combustion engine (not illustrated) flows through the exhaust gas inlet 8 into the turbine housing 4, and flows through the scroll flow passage 16 into the turbine impeller 6, thereby rotating the turbine impeller 6. The exhaust gas thereafter flows through the exhaust gas outlet 10 out of the turbine housing 4.

The compressor housing 5 is provided with an intake port 9 and a discharge port 11. As the turbine impeller 6 rotates as described above, the compressor impeller 7 rotates in conjunction with the rotating shaft 14. The rotating compressor impeller 7 sucks the external air through the intake port 9. The air passes through the compressor impeller 7 and the scroll flow passage 17 to be compressed, and is discharged through the discharge port 11. The compressed air discharged from the discharge port 11 is supplied to the aforementioned internal combustion engine.

The turbine 2 of the turbocharger 1 will further be described. Note that the following description simply stating “axial direction”, “radial direction” and “circumferential direction” shall mean the direction Ds of rotation axis (direction of rotation axis H), the radial direction Dr of rotation, and the circumferential direction De of rotation of the turbine impeller 6, respectively. Also note that the description stating “upstream” and “downstream” shall mean the upstream and the downstream of the exhaust gas in the turbine 2. Also note that, in the direction Ds of the rotation axis H, a side close to the turbine 2 of the turbocharger 1 (left side in FIG. 1) may be simply referred to as “turbine side”, and a side close to the compressor 3 (right side in FIG. 1) as “compressor side” on occasions.

The turbine 2 of the turbocharger 1 has a nozzle flow passage 19 which is provided around the turbine impeller 6, and is structured to connect the scroll flow passage 16 and the turbine impeller 6. The nozzle flow passage 19 has a plurality of movable nozzle vanes 21. The nozzle vanes 21 are arranged almost at equal intervals on a circumference centered round the rotation axis H. The individual nozzle vanes 21 synchronously pivot about an axis NX parallel to the rotation axis H. As a result of such pivoting of the nozzle vanes 21, each gap between the adjacent nozzle vanes 21 widens and narrows, thus controlling aperture of the nozzle flow passage 19.

The turbine 2 has a variable nozzle unit 20 for thus driving the nozzle vanes 21. The variable nozzle unit 20 is fitted inside the turbine housing 4. The variable nozzle unit 20 has the nozzle vanes 21, and two nozzle rings 23, 27 that hold in between the nozzle vanes 21 in the axial direction Ds. The two nozzle rings 23, 27 are arranged in the axial direction Ds, wherein the nozzle ring 23 is arranged closer to the compressor, as compared with the nozzle ring 27. Each of the nozzle rings 23, 27 has a ring shape centered round the rotation axis H, and is arranged so as to surround the turbine impeller 6 in the circumferential direction Dc. A region demarcated between the two nozzle rings 23, 27 in the axial direction Ds forms the nozzle flow passage 19. The nozzle rings 23, 27 are coupled with use of a plurality of coupling pins 29 in the axial direction Ds. With the coupling pins 29 manufactured with high dimensional accuracy, the nozzle flow passage 19 will have high dimensional accuracy in the axial direction Ds.

The variable nozzle unit 20 further has a drive mechanism 25 for driving the nozzle vanes 21. The drive mechanism 25 is accommodated in a space between the nozzle ring 23 and the bearing housing 13, and is structured to transmit a drive force from an external actuator (not illustrated) to the nozzle vanes 21.

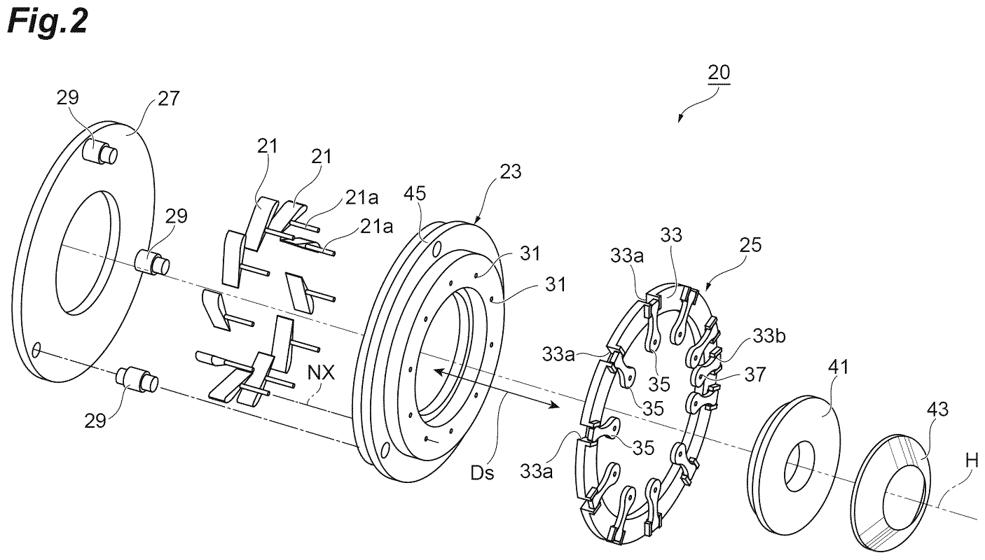

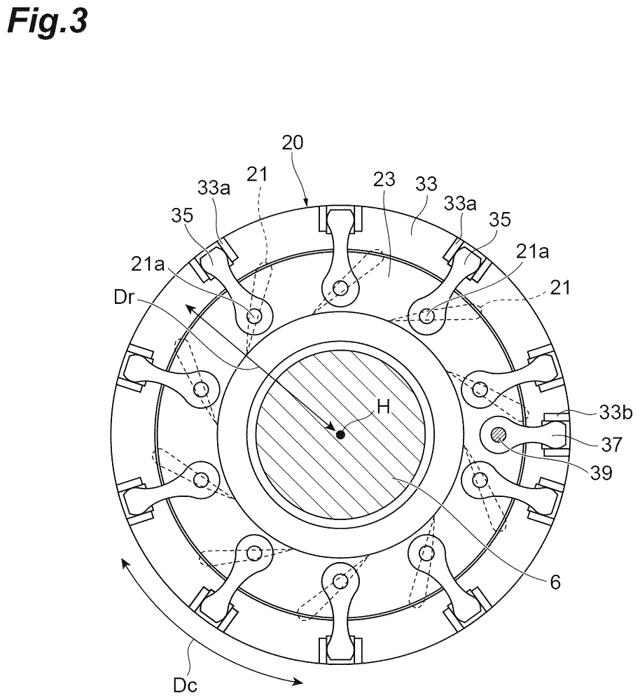

The drive mechanism 25 of the variable nozzle unit 20 will be further detailed, with reference to FIGS. 2 and 3. FIG. 2 is an exploded perspective view illustrating the variable nozzle unit 20, and a heat shielding plate 41 and a disc spring 43 described later. FIG. 3 is a plan view illustrating the variable nozzle unit 20 as viewed in the axial direction Ds from the side of the bearing housing 13. The nozzle ring 23 has bearing holes 31 provided so as to penetrate therethrough in the axial direction Ds. Each bearing hole 31 has inserted therein a pivot shaft 21a of each nozzle vane 21 in a pivotable manner. The nozzle vanes 21 illustrated in FIG. 3 are arranged at regular interval around the circumference. The nozzle vanes 21 may also be arranged at irregular intervals around the circumference.

The drive mechanism 25 has a drive ring 33, nozzle link plates 35, and a drive link plate 37. The drive ring 33 has a ring shape that extends along a circumference centered around the rotation axis H, and is arranged along a face, on the compressor side, of the nozzle ring 23. The drive ring 33 is pivotable about the rotation axis H, relative to the nozzle ring 23. On the drive ring 33, there are engagement parts 33a that engage with the individual nozzle link plates 35, provided at predetermined intervals in the circumferential direction Dc.

There are the same number of nozzle link plates 35 and the nozzle vanes 21. Each nozzle link plate 35 is attached to an end of the pivot shaft 21a of each nozzle vane 21, and extends outwards from the end in the radial direction Dr. More Each pivot shaft 21a of the nozzle vane 21 is inserted into the bearing hole 31, and an end of each pivot shaft 21a protrudes from the nozzle ring 23 towards the compressor side. To the end of each pivot shaft 21a thus protruded, the inner circumferential end of each nozzle link plate 35 is attached. The outer circumferential end of each nozzle link plate 35 meshes with each engagement part 33a of the drive ring 33.

The drive ring 33 is also provided with one input-side engagement part 33b. The input-side engagement part 33b is located between a pair of the engagement parts 33a. The outer circumferential end of the drive link plate 37 meshes with the input-side engagement part 33b. The inner circumferential end of the drive link plate 37 is connected to a drive shaft 39 (FIG. 3) of an external actuator.

When the external actuator pivots, through the drive shaft 39, the drive link plate 37 about an axis parallel to the rotation axis H, the outer circumferential end of the drive link plate 37 pushes the input-side engagement part 33b in the circumferential direction Dc. This pivots the drive ring 33 about the rotation axis H, and the individual engagement parts 33a of the drive ring 33 push the outer circumferential ends of the individual nozzle link plates 35 in the circumferential direction Dc. The individual nozzle link plates 35 then pivot about the axis NX, thus causing pivoting of the individual nozzle vanes 21 fixed to the individual nozzle link plates 35 about the axis NX.

Next, a structure for positioning the aforementioned variable nozzle unit 20 in the turbine housing 4 will be described. As illustrated in FIGS. 1 and 2, a heat shielding plate 41 is provided between the turbine impeller 6 and the bearing housing 13. The heat shielding plate 41 shields radiant heat from the high-temperature turbine housing 4, thereby suppressing temperature rise of the bearing housing 13. The heat shielding plate 41 has an annular shape that surrounds the rotating shaft 14 in the circumferential direction Dc. The heat shielding plate 41 is fitted into the center opening of the nozzle ring 23, from the side of the bearing housing 13.

Between the heat shielding plate 41 and the bearing housing 13, the disc spring 43 is held. The rotating shaft 14 is inserted into a hole at the center of the disc spring 43, whereby the disc spring 43 is arranged along a conical face centered round the rotation axis H which gives the cone axis. One end of disc spring 43 in the axial direction Ds is in contact with the bearing housing 13, The other end is in contact with the heat shielding plate 41. The disc spring 43 generates a repulsive force that acts to stretch the distance between the bearing housing 13 and the heat shielding plate 41 in the axial direction Ds. With the disc spring 43, the variable nozzle unit 20 and the heat shielding plate 41 are biased towards the turbine housing 4, in the axial direction Ds.

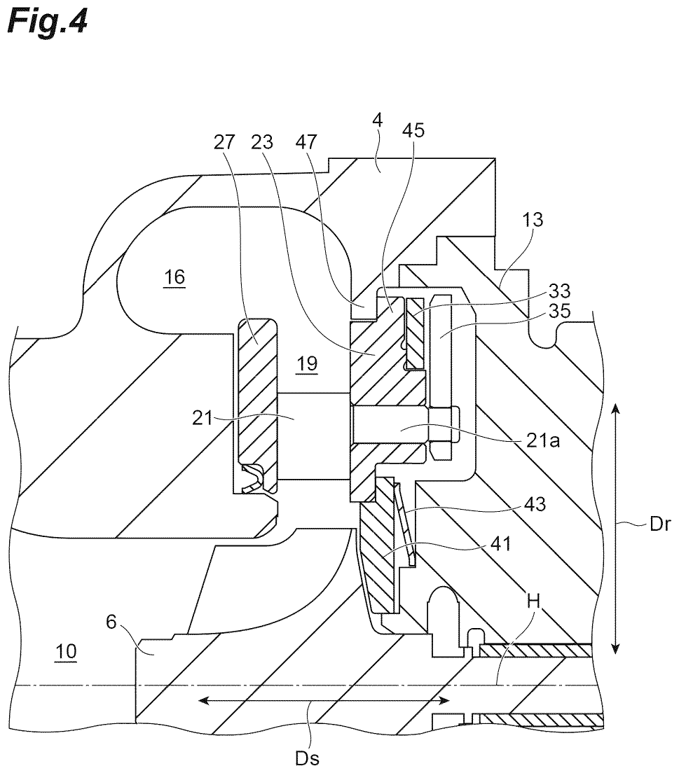

FIG. 4 is an enlarged cross-sectional view illustrating an area at and around the variable nozzle unit 20 illustrated in FIG. 1. The nozzle ring 23 has a flange 45 formed so as to protrude towards the outer circumferential side. On the other hand, the turbine housing 4 has formed therein a flange catcher (e.g., ridge 47) structured to catch the flange 45. The ridge 47 protrudes from the inner wall face of the turbine housing 4 towards the inner circumferential side, and extends in a ring shape along the circumference centered round the rotation axis H. The ridge 47 has the inner diameter smaller than the outer diameter of the flange 45, so that the flange 45 abuts on the ridge 47 from the side of the bearing housing 13.

With such structure, the variable nozzle unit 20 is biased by the disc spring 43, towards the turbine side. With such biasing force, the flange 45 of the nozzle ring 23 is pressed against the ridge 47. With the flange 45 thus pressed against the ridge 47, the variable nozzle unit 20 is positioned in the axial direction Ds, and thus fixed. The variable nozzle unit 20 is fixed with a certain level of fixing force, also in an in-plane direction orthogonal to the axial direction Ds, with the aid of the frictional force that acts between the flange 45 and the ridge 47. Note however if difference of thermal expansion should occur between the variable nozzle unit 20 and the turbine housing 4, such difference of thermal expansion can be absorbed, as a result of sliding between the flange 45 and the ridge 47.

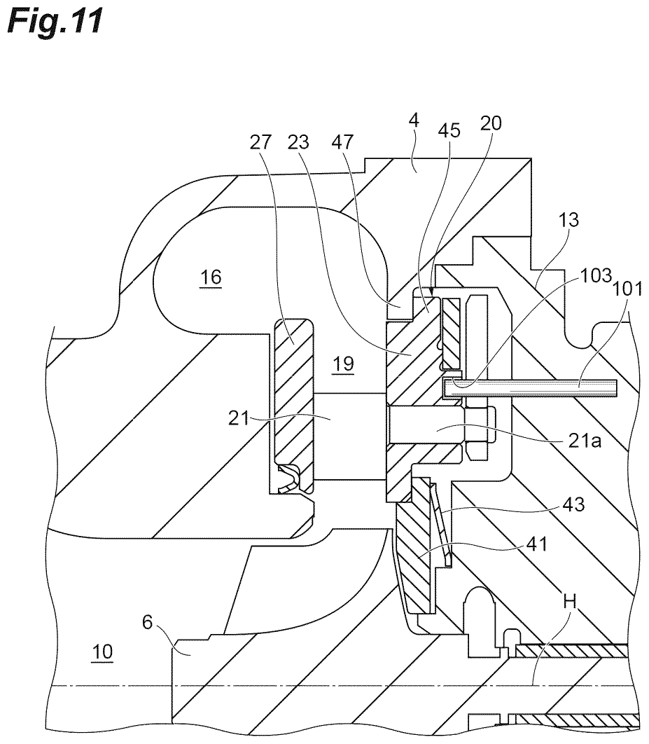

Next, how to position the variable nozzle unit 20 in the circumferential direction Dc and radial direction Dr will be described. As has been described previously, the variable nozzle unit 20 is fixed with a certain level of fixing force, also in an in-plane direction orthogonal to the axial direction Ds, with the aid of the frictional force that acts between the flange 45 and the ridge 47 (flange catcher). In an example structure illustrated in FIG. 11, a pin 101 that extends from the bearing housing 13 towards the turbine side, in the axial direction Ds. The pin 101 is press-fitted into the bearing housing 13, and is positioned so as to be offset in the radial direction Dr from the rotation axis H. The nozzle ring 23 of the variable nozzle unit 20 is provided with a pin hole 103 into which the pin 101 is inserted. By inserting and fitting the pin 101 into the pin hole 103 while leaving a clearance, the variable nozzle unit 20 is positioned in the in-plane direction orthogonal to the axial direction Ds.

The disc spring load applied by the disc spring 43 (biasing part) will, however, decrease during operation of the turbocharger 1, as the disc spring 43 deforms under heating or reduces the Young's modulus. This would reduce frictional force between the flange 45 and the ridge 47, and would cause circumferential shift (pivotal shift about the rotation axis H) of the variable nozzle unit 20 just as much as the clearance between the pin 101 and the pin hole 103. The circumferential shift of the variable nozzle unit 20 will result in change in the flow rate of exhaust gas, particularly when the nozzle flow passage 19 is closed. Now, the turbocharger 1 has a structure explained below, allowed for suppression of the circumferential shift of the variable nozzle unit 20 during operation.

In the turbocharger 1, the circumferential shift of the variable nozzle unit 20 is restricted by engagement of the variable nozzle unit 20 with the turbine housing 4 at a predetermined engagement part. The turbocharger 1 has an engagement mechanism 50A, 50B, 50C, 50D and 50E which restrict a rotational position of the variable nozzle assembly 20. The engagement mechanism 50A, 50B, 50C, 50D and 50E is located in a region radially outside a movable range of the nozzle vane 21 in the radial direction Dr. Each of the engagement mechanism 50A, 50B, 50C, 50D and 50E has a first engagement structure formed on the nozzle ring 23, and a second engagement structure formed on the turbine housing 4.

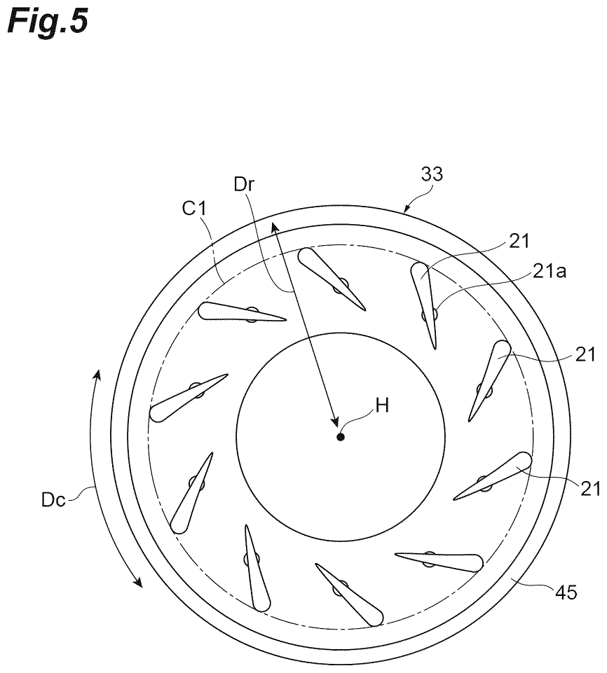

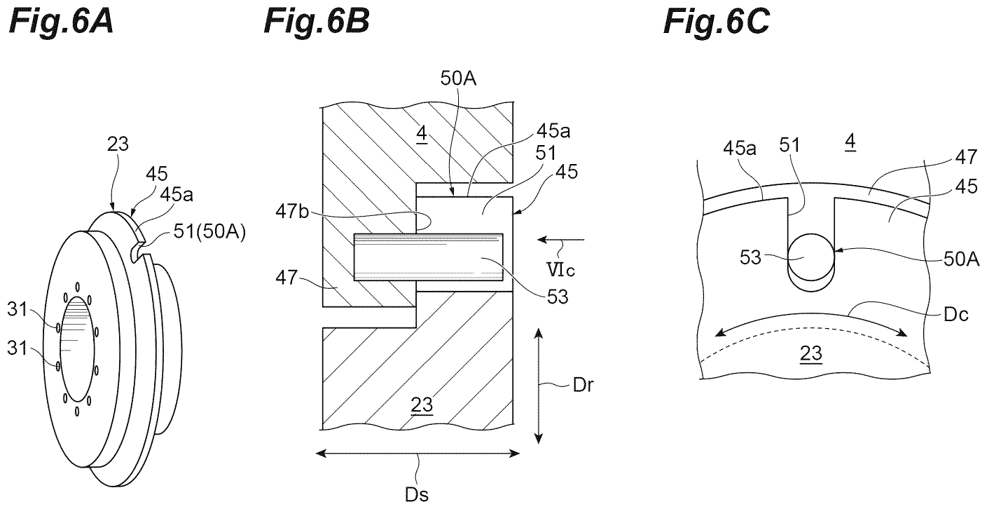

FIG. 5 is a drawing illustrating a nozzle ring 23 and the nozzle vanes 21, viewed in an axial direction Ds from the turbine side. In the turbocharger 1 illustrated in FIG. 6, the engagement mechanism 50A is provided to a region radially outside a circle C1 illustrated in the drawing. The circle C1 is a circle circumscribing the individual nozzle vanes 21 when the aperture of the nozzle flow passage 19 becomes maximum. The region radially outside the circle C1 therefore means a region radially outside the movable range of the nozzle vanes 21. As is geometrically obvious, the more outwardly the engagement mechanism 50A between the variable nozzle unit 20 and the turbine housing 4 is positioned in the radial direction Dr, the smaller the circumferential shift of the variable nozzle unit 20 ascribed to the circumferential clearance of the engagement mechanism 50A will be. Therefore, in the turbocharger 1, by arranging the engagement mechanism 50A on the outer circumferential side as far as possible, such as in a region radially outside the circle C1, the circumferential shift of the variable nozzle unit 20 during operation is suppressed, whereby change in the flow rate of exhaust gas in the nozzle flow passage 19 may be suppressed.

Some examples of the engagement mechanisms between the variable nozzle unit 20 and the turbine housing 4 in a region radially outside the circle C1 will be described. Each of the engagement parts 50A, 50B, 50C, 50D and 50E described below is provided at a position of the flange 45 of the nozzle ring 23 in the variable nozzle unit 20. The flange 45 of the nozzle ring 23 extends in the circumferential direction Dc with a constant width over the entire circumference, and is located in a region radially outside the circle C1. As illustrated in FIG. 4, the flange 45 is a part of the variable nozzle unit 20, which protrudes most outwardly in the radial direction Dr.

FIG. 6A is a perspective view illustrating the nozzle ring 23 to which the engagement mechanism 50A is applied, FIG. 6B is an enlarged cross-sectional view illustrating the engagement mechanism 50A, and FIG. 6C is a drawing illustrating the engagement mechanism 50A viewed from a direction of arrow VIc. As illustrated in FIG. 6A, the engagement mechanism 50A has a first engagement structure (e.g., pin receptor) formed in the flange 45 of the nozzle ring 23. The pin receptor (e.g., U-notch 51) is formed by notching the flange 45 over the entire thickness of the flange 45 from the outermost end face 45a towards the inner circumferential side, with the depth of notch aligned to the radial direction Dr. As illustrated in FIGS. 6B and 6C, the engagement mechanism 50A has a second engagement structure (e.g., pin 53) which is provided to the ridge 47 and inserted into the U-notch 51. The pin 53 is press-fitted into the flange catcher face 47b of the ridge 47, and extends from the flange catcher face 47b towards the compressor in the axial direction Ds. The pin 53 may be a solid pin made of a solid member, or a coiled pin. The pin 53 has a circular cross section whose diameter is nearly equal to the width of the U-notch 51, and is fitted to the U-notch 51 while leaving a clearance.

With such engagement mechanism 50A, the circumferential shift of the variable nozzle unit 20 is restricted. The variable nozzle unit 20 can shift in the circumferential direction Dc, just as much as the circumferential clearance between the U-notch 51 and the pin 53. However, the circumferential shift of the variable nozzle unit 20 due to the circumferential clearance may be suppressed as described previously, since the engagement mechanism 50A is provided to a position of the flange 45 which is the outermost circumferential part of the variable nozzle unit 20. Accordingly, the turbocharger 1 having the engagement mechanism 50A can suppress the circumferential shift of the variable nozzle unit 20 during operation, and can therefore suppress change in the flow rate of exhaust gas in the nozzle flow passage 19.

In a reference structure illustrated in FIG. 11, a pin 101, is provided to the bearing housing 13 whose temperature during operation is lower than that of the nozzle ring 23. Hence, this creates temperature difference between the pin 101 and the nozzle ring 23, and tends to increase the clearance between the pin 101 and the pin hole 103 due to difference of thermal expansion. In contrast, the pin 53 in the engagement structure 50A (FIG. 6) is provided to the turbine housing 4 whose temperature is equivalent to that of the nozzle ring 23, so that the temperature difference between the pin 53 and the nozzle ring 23 during operation is small, thus successfully reducing the clearance in between.

The engagement structure 50A is a part where the turbine housing 4 and the nozzle ring 23 are engaged. Therefore, if the engagement structure 50A were arranged in a region radially inside the circle C1, a part of the engagement part 50A (pin 53, for example) would interfere with pivoting of the nozzle vanes 21. In contrast, since the engagement structure 50A in the turbocharger 1 illustrated in FIG. 6 resides radially outside the circle C1, so that the engagement structure 50A is prevented from interfering with pivoting of the nozzle vanes 21. Also note, since the pin 53 is fitted into the U-notch 51 while leaving a clearance, so that the pin 53 shifts within the U-notch 51 in the radial direction Dr if difference in thermal expansion should occur between the variable nozzle unit 20 and the turbine housing 4, whereby the aforementioned difference in thermal expansion is absorbed.

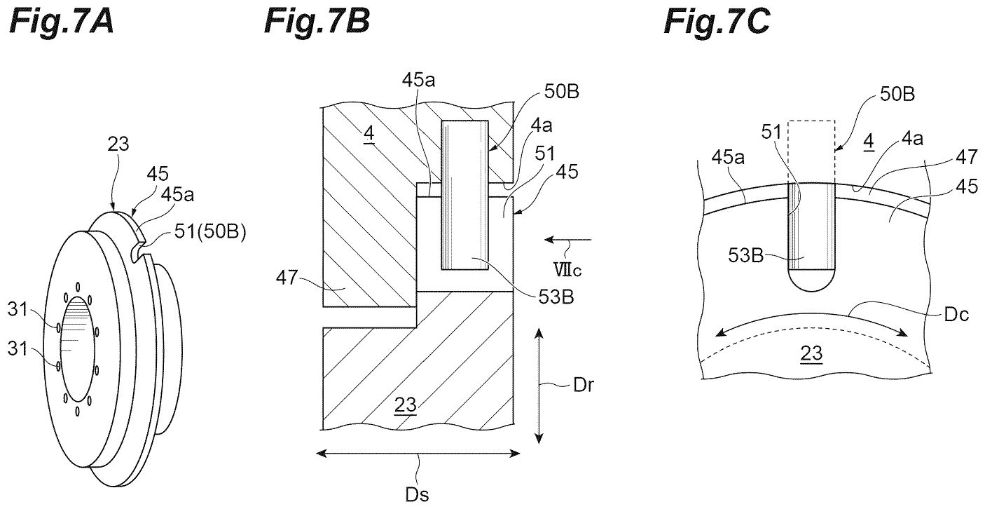

FIG. 7A is a perspective view illustrating the nozzle ring 23 to which the engagement structure 50B is applied, FIG. 7B is an enlarged cross-sectional view illustrating the engagement structure 50B, and FIG. 7C is a drawing illustrating the engagement structure 50B viewed from a direction of arrow VIIc. As illustrated in FIG. 7A, the engagement structure 50B has a first engagement structure (e.g., pin receptor, U-notch 51). As illustrated in FIGS. 7B and 7C, a second engagement structure (e.g., pin 53B) of the engagement structure 50B is press-fitted into the inner wall face 4a of the turbine housing 4, at a position facing the outermost end face 45a of the flange 45, and protrudes radially inwards from the inner wall face 4a. The pin 53B has a circular cross section whose diameter is nearly equal to the width of the U-notch 51, inserted into the U-notch 51 in the depth direction of the notch, and fitted thereto while leaving a clearance. Also with such engagement structure 50B, operations and effects similar to those of the engagement structure 50A are obtainable.

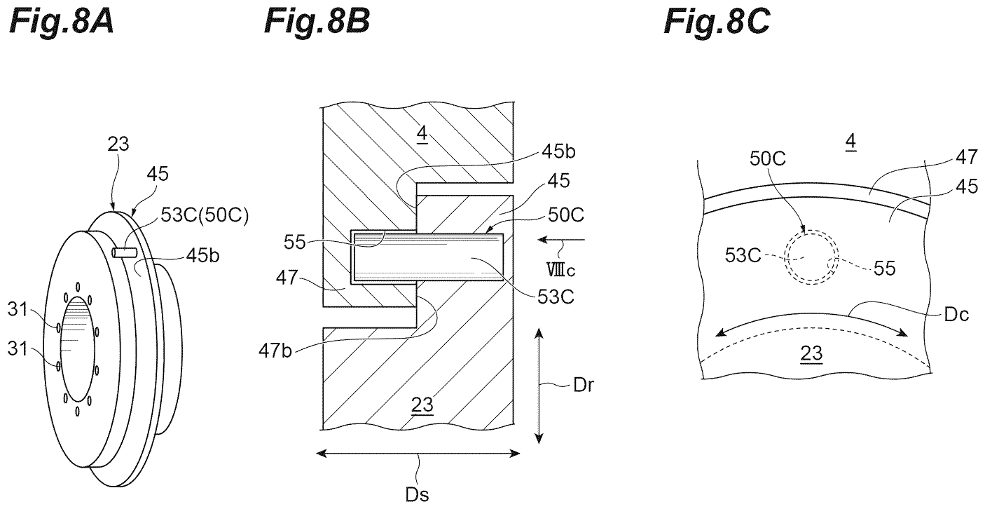

FIG. 8A is a perspective view illustrating the nozzle ring 23 to which the engagement structure 50C is applied, FIG. 8B is an enlarged cross-sectional view illustrating the engagement structure 50C, and FIG. 8C is a drawing illustrating the engagement structure 50C viewed from a direction of arrow VIIIc. As illustrated in FIG. 8A, the engagement structure 50C has a first engagement structure (e.g., pin 53C) provided to the flange 45 of the nozzle ring 23. The pin 53C is press-fitted into the flange 45, for example, into a contact face 45b thereof to be brought into contact with the flange catcher face 47b, and extends from the contact face 45b towards the turbine side in the axial direction Ds. As illustrated in FIGS. 8B and 8C, the engagement structure 50C has a second engagement structure (e.g., pin receptor) provided to the turbine housing 4, and into which the pin 53C is inserted. The pin receptor (e.g., pin hole 55) is provided in the flange catcher face 47b of the ridge 47, and has a circular cross section whose diameter is nearly equal to that of the pin 53C. The pin 53C is fitted into the pin hole 55, while leaving a clearance. Also with such engagement structure 50C, operations and effects similar to those of the engagement structure 50A are obtainable. Note that, such positional relation between the pin 53C and the pin hole 55 may be inverted, where the pin 53C may be formed on the flange catcher face 47b of the ridge 47, while the corresponding pin hole 55 may be formed in the contact face 45b of the flange 45.

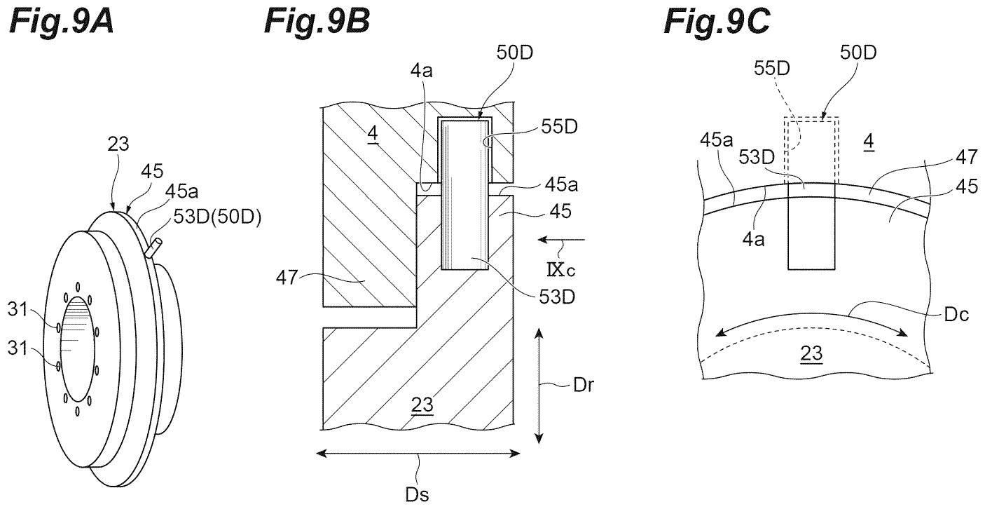

FIG. 9A is a perspective view illustrating the nozzle ring 23 to which the engagement structure 50D is applied, FIG. 9B is an enlarged cross-sectional view illustrating the engagement structure 50D, and FIG. 9C is a drawing illustrating the engagement structure 50D viewed from a direction of arrow IXc. As illustrated in FIG. 9A, the engagement structure 50D has a first engagement structure (e.g., pin 53D) provided to the flange 45 of the nozzle ring 23. The pin 53D is press-fitted into the outermost end face 45a of the flange 45, and protrudes radially outwards from the outermost end face 45a. As illustrated in FIGS. 9B and 9C, the engagement structure 50D has a second engagement structure (e.g., pin hole 55D) provided to the turbine housing 4, and into which the pin 53D is inserted. The pin hole 55D is provided in the inner wall face 4a of the turbine housing 4, at a position facing the outermost end face 45a of the flange 45, and has a circular cross section whose diameter is nearly equal to that of the pin 53D. The pin 53D is fitted into the pin hole 55D, while leaving a clearance. Also with such engagement structure 50D, operations and effects similar to those of the engagement structure 50A are obtainable. Note that, such positional relation between the pin 53D and the pin hole 55D may be inverted, where the pin 53D may be formed on the inner wall face 4a of the turbine housing 4, while the corresponding pin hole 55D may be formed in the contact face 45b of the flange 45.

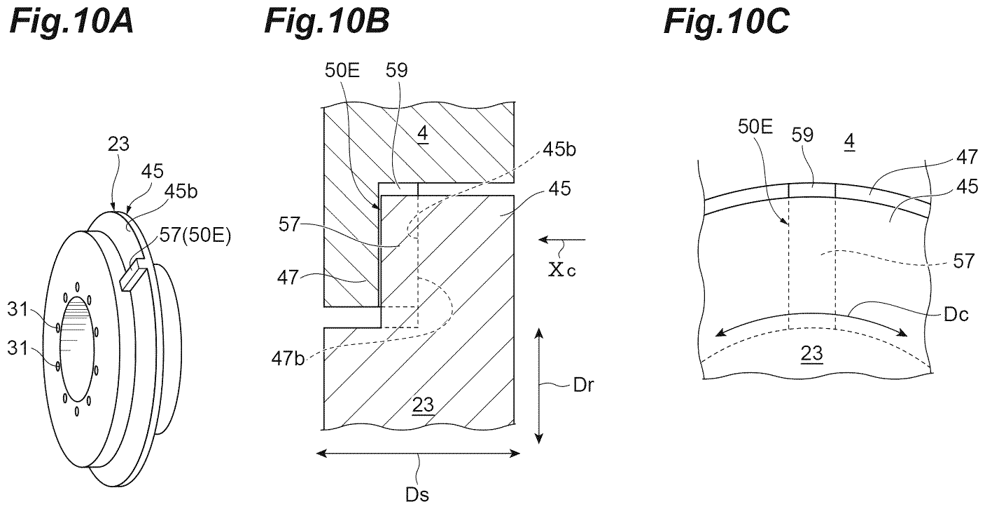

FIG. 10A is a perspective view illustrating the nozzle ring 23 to which the engagement structure 50E is applied, FIG. 10B is an enlarged cross-sectional view illustrating the engagement structure 50E, and FIG. 10C is a drawing illustrating the engagement structure 50E viewed from a direction of arrow Xc. As illustrated in FIG. 10A, the engagement structure 50E has a first engagement structure (e.g., protrusion 57) formed on the flange 45 of the nozzle ring 23. The protrusion 57 is shaped as a rectangular parallelepiped that protrudes from the contact face 45b of the flange 45 towards the turbine side, and extends over the entire radial width of the flange 45 in the radial direction Dr. The protrusion 57 may be formed as an unmachined part in the process of machining the contact face 45b. As illustrated in FIGS. 10B and 10C, the engagement structure 50E also has a second engagement structure (e.g., recess 59) corresponded to the protrusion 57. The recess 59 is formed in the flange catcher face 47b, in a shape allowed for just fitting of the protrusion 57. That is, the recess 59 is formed in the flange catcher face 47b so as to be shaped in a rectangular parallelepiped whose circumferential width is nearly equal to that of the protrusion 57. The recess 59 is also a trench that extends over the entire radial width of the ridge 47 in the radial direction Dr. The protrusion 57 is fitted into the recess 59, while leaving a clearance. Also with such engagement structure 50E, operations and effects similar to those of the engagement structure 50A are obtainable. The recess 59 is not limited a rectangular parallelepiped shape. The recess 59 may have two faces that hold the protrusion 57 in between in the circumferential direction Dc. The protrusion 57 is not limited to that having a shape of rectangular parallelepiped, and may have any other shape as long as it protrudes from the contact face 45b towards the turbine side. Note that, such positional relation between the protrusion 57 and the recess 59 may be inverted, wherein the protrusion 57 may be formed on the flange catcher face 47b of the ridge 47, while the corresponding recess 59 may be formed in the contact face 45b of the flange 45.

Having described the examples, the present disclosure is not limited to the aforementioned examples, and may be modified. The structures of the examples may be appropriately combined for use.

For example, all of the engagement structures 50A to 50E, although having been presented in the aforementioned examples as a part where the turbine housing 4 and the nozzle ring 23 are engaged, may alternatively be presented as a part where the bearing housing 13 and the nozzle ring 23 are engaged. In this case, for example, the pin 53 of the engagement structure 50A may be press-fitted into the bearing housing 13, and inserted into the U-notch 51. That is, the engagement structures 50A to 50E may be located in a region radially outside the circle C1, so that the nozzle ring 23 may be engaged either with the turbine housing 4 or the bearing housing 13. As long as such engagement structures 50A to 50E are located in the region radially outside the circle C1, the circumferential shift of the variable nozzle unit 20 ascribed to the clearance in the circumferential direction Dc of the engagement structures 50A to 50E may be suppressed low, whereby change in the flow rate of exhaust gas through the nozzle flow passage 19 may be suppressed.

Also note that each of the engagement structures 50A to 50E, having been provided in the aforementioned examples at one position per variable nozzle unit 20, may alternatively be provided at a plurality of places in the circumferential direction Dc per variable nozzle unit 20.

It is to be understood that not all aspects, advantages and features described herein may necessarily be achieved by, or included in, any one particular example. Indeed, having described and illustrated various examples herein, it should be apparent that other examples may be modified in arrangement and detail.

Some additional examples are disclosed as follows, with continued reference to the drawings for convenience of description.

An example variable capacity turbocharger (1) includes a turbine impeller (6); a turbine housing (4) accommodating the turbine impeller (6); a nozzle flow passage (19) located around the turbine impeller (6) in the turbine housing (4); a variable nozzle assembly (20) having a nozzle vane (21) located in the nozzle flow passage (19), and a drive mechanism (25) configured to drive the nozzle vane (21); and an engagement mechanism (50A) configured to restrict a rotational position of the variable nozzle assembly (20). The engagement mechanism (50A) is located in a region radially outside a movable range of the nozzle vane (21) in a radial direction of rotation of the turbine impeller (6).

The variable capacity turbocharger (1) may include a biasing part (43) configured to bias the variable nozzle assembly (20) in a direction of a rotation axis of the turbine impeller (6) so as to be pressed against the turbine housing (4).

In the turbocharger (1), the variable nozzle assembly (20) may include: a nozzle ring (23) supporting the nozzle vane (21); a flange (45) that forms an outer surface of the nozzle ring (23) in the radial direction. The turbine housing (4) may include a flange catcher (47). The flange (45) may be pressed under biasing force of the biasing part (43) against the flange catcher (47) in the direction of the rotation axis.

In the turbocharger (1), the engagement mechanism (50A) may engage directly or indirectly with the flange (45).

In the turbocharger (1), the engagement mechanism (50A) may include: a notch located in an outermost end face of the flange (45) that faces towards an inner circumferential side; and a pin (53) that extends from the turbine housing (4) and is inserted into the notch.

In the turbocharger (1), the engagement mechanism (50A) may include a pin (53) and a pin hole (55) arrangement that is configured to engage the flange (45) to the turbine housing (4) when the pin (53) is inserted into the pin hole (55).

In the turbocharger (1), the engagement mechanism (50A) may include a protrusion (57) and a recess (59) arrangement that is configured to engage the flange (45) to the flange catcher (47) when the protrusion (57) is inserted into the recess (59).

An example variable capacity turbocharger (1) including: a turbine impeller (6); a nozzle flow passage (19) located around the turbine impeller (6); a nozzle vane (21) located in the nozzle flow passage (19); a nozzle ring (23) supporting the nozzle vane (21); and an engagement mechanism (50A) configured to restrict a rotational position of the nozzle ring (23). The engagement mechanism (50A) may be located in a region radially outside a movable range of the nozzle vane (21) in a radial direction of the turbine impeller (6).

The variable capacity turbocharger (1) may include a turbine housing (4) accommodating the turbine impeller (6), and a biasing part (43) configured to bias the nozzle ring (23) in a direction of a rotation axis of the turbine impeller (6) so as to be pressed against the turbine housing (4).

The variable capacity turbocharger (1) may include a turbine housing (4) accommodating the turbine impeller (6). The engagement mechanism (50A) may include a first engagement structure formed on the nozzle ring (23), and a second engagement structure formed on the turbine housing (4). The second engagement structure may be configured to engage the first engagement structure to restrict the rotational position of the nozzle ring (23). The first engagement structure and the second engagement structure may be located in the region radially outside the movable range of the nozzle vane (21) in the radial direction of the turbine impeller (6).

In the variable capacity turbocharger (1), the nozzle ring (23) may include a flange (45) that forms an outer surface of the nozzle ring (23) in the radial direction. The first engagement structure may be formed on the flange (45).

In the variable capacity turbocharger (1), the turbine housing (4) may include a flange catcher (47) contacting with the flange (45) in a direction of a rotation axis of the turbine impeller (6). The second engagement structure is formed on the flange catcher (47).

In the variable capacity turbocharger (1), the first engagement structure may include a pin (53) extending from the flange catcher (47) in the direction of the rotation axis. The second engagement structure may include a pin receptor (51) in which the pin (53) is inserted.

In the variable capacity turbocharger (1), the pin receptor (51) may include a notch or a hole.

In the variable capacity turbocharger (1), the second engagement structure may include a pin (53) extending from the flange (45) in the direction of the rotation axis. The first engagement structure may include a pin receptor (51) in which the pin (53) is inserted.

In the variable capacity turbocharger (1), the second engagement structure may include a protrusion (57) protruding from the flange (45) in the direction of the rotation axis. The first engagement structure may include a recess (59) formed on the flange catcher (47). The recess (59) may extend in the radial direction, into which the protrusion (57) is fitted.

The variable capacity turbocharger (1) may include a turbine housing (4) accommodating the turbine impeller (6). The engagement mechanism (50A) may include a pin (53) and a pin receptor (51) arrangement that is configured to engage the nozzle ring (23) to the turbine housing (4) when the pin (53) is inserted into the pin receptor (51).

In the variable capacity turbocharger (1), the pin (53) may extend from the nozzle ring (23), and the pin receptor (51) may be formed on the turbine housing (4).

In the variable capacity turbocharger (1), the nozzle ring (23) may include a flange (45) that forms an outer surface of the nozzle ring (23) in the radial direction. The pin (53) may extend from the nozzle ring (23). The pin receptor (51) may be formed on the flange (45).

The variable capacity turbocharger (1) may include a turbine housing (4) accommodating the turbine impeller (6). The engagement mechanism (50A) may include a protrusion (57) and a recess (59) arrangement that is configured to engage the nozzle ring (23) to the turbine housing (4) when the protrusion (57) is inserted into the recess (59).

What is claimed is:

1. A variable capacity turbocharger comprising:
a turbine impeller;
a turbine housing accommodating the turbine impeller;
a nozzle flow passage located around the turbine impeller in the turbine housing;
a variable nozzle assembly having a nozzle vane located in the nozzle flow passage, and a drive mechanism configured to drive the nozzle vane; and
an engagement mechanism configured to restrict a rotational position of the variable nozzle assembly, wherein the engagement mechanism is located in a region radially outside a movable range of the nozzle vane in a radial direction of rotation of the turbine impeller.

2. The variable capacity turbocharger according to claim 1, further comprising a biasing part configured to bias the variable nozzle assembly in a direction of a rotation axis of the turbine impeller so as to be pressed against the turbine housing.

3. The variable capacity turbocharger according to claim 2,
wherein the variable nozzle assembly includes:
a nozzle ring supporting the nozzle vane;
a flange that forms an outer surface of the nozzle ring in the radial direction,
wherein the turbine housing includes a flange catcher, and
wherein the flange is pressed under biasing force of the biasing part against the flange catcher in the direction of the rotation axis.

4. The variable capacity turbocharger according to claim 3, wherein the engagement mechanism engages directly or indirectly with the flange.

5. The variable capacity turbocharger according to claim 3, wherein the engagement mechanism includes:
a notch located in an outermost end face of the flange that faces towards an inner circumferential side; and
a pin that extends from the turbine housing and is inserted into the notch.

6. The variable capacity turbocharger according to claim 3, wherein the engagement mechanism includes a pin and a pin hole arrangement that is configured to engage the flange to the turbine housing when the pin is inserted into the pin hole.

7. The variable capacity turbocharger according to claim 3, wherein the engagement mechanism includes a protrusion and a recess arrangement that is configured to engage the flange to the flange catcher when the protrusion is inserted into the recess.

8. A variable capacity turbocharger comprising:
a turbine impeller;
a nozzle flow passage located around the turbine impeller;
a nozzle vane located in the nozzle flow passage;
a nozzle ring supporting the nozzle vane; and
an engagement mechanism configured to restrict a rotational position of the nozzle ring, wherein the engagement mechanism is located in a region radially outside a movable range of the nozzle vane in a radial direction of the turbine impeller.

9. The variable capacity turbocharger according to claim 8, further comprising:
a turbine housing accommodating the turbine impeller; and
a biasing part configured to bias the nozzle ring in a direction of a rotation axis of the turbine impeller so as to be pressed against the turbine housing.

10. The variable capacity turbocharger according to claim 8, further comprising a turbine housing accommodating the turbine impeller,
wherein the engagement mechanism includes:
a first engagement structure formed on the nozzle ring; and
a second engagement structure formed on the turbine housing, wherein the second engagement structure is configured to engage the first engagement structure to restrict the rotational position of the nozzle ring, and
wherein the first engagement structure and the second engagement structure are located in the region radially outside the movable range of the nozzle vane in the radial direction of the turbine impeller.

11. The variable capacity turbocharger according to claim 10,
wherein the nozzle ring includes a flange that forms an outer surface of the nozzle ring in the radial direction, and
wherein the first engagement structure is formed on the flange.

12. The variable capacity turbocharger according to claim 11,
wherein the turbine housing includes a flange catcher contacting with the flange in a direction of a rotation axis of the turbine impeller, and
wherein the second engagement structure is formed on the flange catcher.

13. The variable capacity turbocharger according to claim 12,
wherein the first engagement structure includes a pin extending from the flange catcher in the direction of the rotation axis, and
wherein the second engagement structure includes a pin receptor in which the pin is inserted.

14. The variable capacity turbocharger according to claim 13, wherein the pin receptor includes a notch or a hole.

15. The variable capacity turbocharger according to claim 12,
wherein the second engagement structure includes a pin extending from the flange in the direction of the rotation axis, and
wherein the first engagement structure includes a pin receptor in which the pin is inserted.

16. The variable capacity turbocharger according to claim 12,
wherein the second engagement structure includes a protrusion protruding from the flange in the direction of the rotation axis,
wherein the first engagement structure includes a recess formed on the flange catcher, and
wherein the recess extends in the radial direction, into which the protrusion is fitted.

17. The variable capacity turbocharger according to claim 8, further comprising a turbine housing accommodating the turbine impeller,
wherein the engagement mechanism includes a pin and a pin receptor arrangement that is configured to engage the nozzle ring to the turbine housing when the pin is inserted into the pin receptor.

18. The variable capacity turbocharger according to claim 17,
wherein the pin extends from the nozzle ring, and
wherein the pin receptor is formed on the turbine housing.

19. The variable capacity turbocharger according to claim 17,
wherein the nozzle ring includes a flange that forms an outer surface of the nozzle ring in the radial direction,
wherein the pin extends from the turbine housing, and
wherein the pin receptor is formed on the flange.

20. The variable capacity turbocharger according to claim 8, further comprising a turbine housing accommodating the turbine impeller,
wherein the engagement mechanism includes a protrusion and a recess arrangement that is configured to engage the nozzle ring to the turbine housing when the protrusion is inserted into the recess.
